(19) United States
(12) Patent Application Publication
(10) Pub. No.: US 2007/0127824 A1
(43) Pub. Date: Jun. 7, 2007

(54) Method and apparatus for classifying a vehicle occupant via a non-parametric learning algorithm

(75) Inventors: Yun Luo, Livonia, MI (US); Xiuling Su, Westland, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive U.S. LLC

(21) Appl. No.: 11/299,113

(22) Filed: Dec. 7, 2005

(51) Int. Cl. G06K 9/62; G06K 9/46; G06K 9/00

(52) U.S. Cl. 382/224; 382/190; 382/104

(57) ABSTRACT

Systems and methods are provided for classifying an input feature vector, representing a vehicle occupant, into one of a plurality of occupant classes. A database (106) contains a plurality of feature vectors in a multidimensional feature space. Each feature vector has an associated class from the plurality of output classes. A data pruner (108) eliminates redundant feature vectors from the database. A data modeler (109) constructs an instance-based, non-parametric classification model (110) in the multidimensional feature space from the plurality of feature vectors. A class discriminator (112) selects an occupant class from the plurality of occupant classes according to the constructed classification model.

### TECHNICAL FIELD

The present invention is directed generally to pattern recognition classifiers and is particularly directed to a method and apparatus for determining an associated class of a vehicle occupant from a plurality of occupant classes.

### BACKGROUND OF THE INVENTION

Actuatable occupant restraining systems having an inflatable air bag in vehicles are known in the art. Such systems that are controlled in response to whether the seat is occupied, an object on the seat is animate or inanimate, a rearward facing child seat present on the seat, and/or in response to the occupant's position, weight, size, etc., are referred to as smart restraining systems. One example of a smart actuatable restraining system is disclosed in U.S. Pat. No. 5,330,226.

Pattern recognition systems can be loosely defined as systems capable of distinguishing between classes of real world stimuli according to a plurality of distinguishing characteristics, or features, associated with the classes. A number of pattern recognition systems are known in the art, including various neural network classifiers, self-organizing maps, and Bayesian classification models. Neural networks, although popular for many pattern classification applications, are non-deterministic. When classifying samples in a feature space having a high dimensionality, it can be difficult or impossible to map the decision boundary between output classes within the feature space. Accordingly, in systems utilizing a large number of input features, the performance of the neural network can not be accurately predicted. In an automotive safety system, it is desirable to have reliable knowledge of the robustness of the classifier.

### SUMMARY OF THE INVENTION

In accordance with an aspect of the present invention, a system is provided for classifying an input feature vector, representing a vehicle occupant, into one of a plurality of occupant classes. A database contains a plurality of feature vectors in a multidimensional feature space. Each feature vector has an associated class from the plurality of output classes. A data pruner eliminates redundant feature vectors from the database. A data modeler constructs an instance-based, non-parametric classification model in the multidimensional feature space from the plurality of feature vectors. A class discriminator selects an occupant class from the plurality of occupant classes according to the constructed classification model.

In accordance with another aspect of the present invention, a method is provided for classifying an occupant into one of a plurality of output classes. Training data is generated, comprising a plurality of feature vectors in a multidimensional feature space. Each feature vector has an associated class from the plurality of output classes. Redundant feature vectors are eliminated from the training data, such that a feature vector from the plurality of feature vectors is eliminated when the feature vector falls within a first threshold distance of another feature vector having the same associated class and beyond a second threshold distance of all feature vectors having a different associated class. An instance-based, non-parametric classification model is constructed in the multidimensional feature space from the plurality of feature vectors. Features are extracted from sensor data associated with a vehicle occupant, such that an input feature vector can be determined in the multidimensional feature space to represent the vehicle occupant. An output class is assigned to the vehicle occupant according to the determined input feature vector and the constructed classification model.

In accordance with yet another aspect of the present invention, a computer program product, operative in a data processing system and recorded on a computer readable medium, is provided for classifying a vehicle occupant. A database contains a plurality of feature vectors in a multidimensional feature space. Each feature vector has an associated class from the plurality of output classes. A data pruning module eliminates redundant feature vectors from the plurality of feature vectors. A data modeling module constructs an instance-based, non-parametric classification model in the multidimensional feature space from the plurality of feature vectors. A class discriminator module selects an occupant class for the vehicle occupant from the plurality of occupant classes according to the constructed classification model and an input feature vector representing the occupant.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a schematic illustration of an actuatable restraining system including at least one sensor, such as a camera or weight sensor, for determining characteristics of a vehicle occupant in accordance with an exemplary implementation of the present invention;

FIG. 2 illustrates a classification system for classifying a vehicle occupant in accordance with an aspect of the present invention;

FIG. 3 illustrates a method for classifying a vehicle occupant in accordance with an aspect of the present invention;

FIG. 4 illustrates an exemplary kernel-based methodology for classifying a vehicle occupant in accordance with an aspect of the present invention;

FIG. 5 illustrates an exemplary nearest neighbor methodology for classifying a vehicle occupant in accordance with an aspect of the present invention;

FIG. 6 illustrates a computer system that can be employed to implement systems and methods described herein.

### DESCRIPTION OF PREFERRED EMBODIMENT

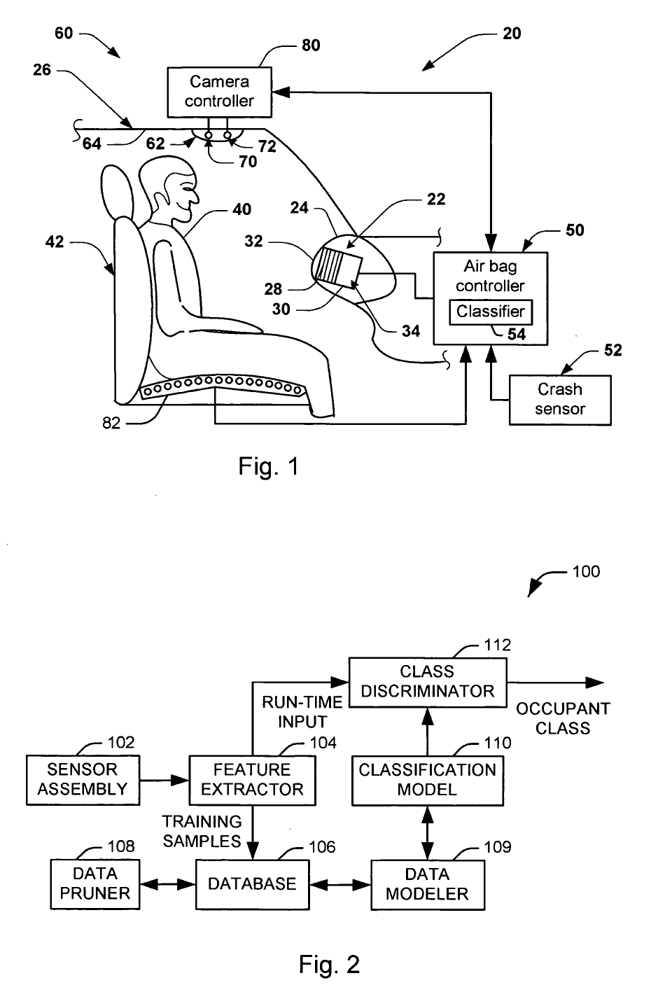

Referring to FIG. 1, an exemplary embodiment of an actuatable occupant restraint system 20, in accordance with the present invention, includes an air bag assembly 22 mounted in an opening of a dashboard or instrument panel 24 of a vehicle 26. The air bag assembly 22 includes an air bag 28 folded and stored within the interior of an air bag housing 30. A cover 32 covers the stored air bag and is adapted to open easily upon inflation of the air bag 28.

The air bag assembly 22 further includes a gas control portion 34 that is operatively coupled to the air bag 28. The gas control portion 34 may include a plurality of gas sources (not shown) and vent valves (not shown) for, when individually controlled, controlling the air bag inflation, e.g., timing, gas flow, bag profile as a function of time, gas pressure, etc. Once inflated, the air bag 28 may help protect an occupant 40, such as a vehicle passenger, sitting on a vehicle seat 42. Although the embodiment of FIG. 1 is described with regard to a vehicle passenger seat, it is applicable to a vehicle driver seat and back seats and their associated actuatable restraining systems. The present invention is also applicable to the control of side actuatable restraining devices and to actuatable devices deployable in response to rollover events.

An air bag controller 50 is operatively connected to the air bag assembly 22 to control the gas control portion 34 and, in turn, inflation of the air bag 28. The air bag controller 50 can take any of several forms such as a microcomputer, discrete circuitry, an application-specific-integrated-circuit (“ASIC”), etc. The controller 50 is further connected to a vehicle crash sensor 52, such as one or more vehicle crash accelerometers. The controller monitors the output signal(s) from the crash sensor 52 and, in accordance with an air bag control algorithm using a deployment control algorithm, determines if a deployment event is occurring, i.e., one for which it may be desirable to deploy the air bag 28. There are several known deployment control algorithms responsive to deployment event signal(s) that may be used as part of the present invention. Once the controller 50 determines that a deployment event is occurring using a selected crash analysis algorithm, for example, and if certain other occupant characteristic conditions are satisfied, the controller 50 controls inflation of the air bag 28 using the gas control portion 34, e.g., timing, gas flow rate, gas pressure, bag profile as a function of time, etc.

The air bag control algorithm associated with the controller 50 can be made sensitive to determined characteristics of the vehicle occupant 40. For example, if the determined characteristics indicate that the occupant 40 is an object, such as a shopping bag, and not a human being, actuating the air bag during a crash event serves no purpose. Accordingly, the air bag controller 50 can include a pattern recognition classifier assembly 54 operative to distinguish between a plurality of occupant classes based on the determined characteristics, and a selected occupant class can then, in turn, be used to control the air bag. It will be appreciated that the classifier 54 can be implemented as an independent module that communicates with air bag controller 50 or, alternatively, be intergrated into the air bag controller 50.

Accordingly, the air bag restraining system 20, in accordance with the present invention, further includes an array of weight sensors 82 that indicates the distribution of weight on the vehicle seat 42 or/and a stereo-vision assembly 60. The weight sensors can be distributed across the surface of the seat as to provide a two-dimensional representation of the pressure applied on the seat by the presence of the occupant. The output of each sensor in the array 82 can be provided to the air bag controller 50 and used as inputs to the pattern recognition classifier 54.

The stereo-vision assembly 60 can include stereo-cameras 62 preferably mounted to the headliner 64 of the vehicle 26. The stereo-vision assembly 60 includes a first camera 70 and a second camera 72, both connected to a camera controller 80. In accordance with one exemplary embodiment of the present invention, the cameras 70, 72 are spaced apart by approximately 35 millimeters (“mm”), although other spacing can be used. The cameras 70, 72 are positioned in parallel with the front-to-rear axis of the vehicle, although other orientations are possible.

The camera controller 80 can take any of several forms such as a microcomputer, discrete circuitry, ASIC, etc. The camera controller 80 is connected to the air bag controller 50 and provides a signal to the air bag controller 50 to provide data relating to various image characteristics of the occupant seating area, which can range from an empty seat, an object on the seat, a human occupant, etc. Herein, image data of the seating area is generally referred to as occupant data, which includes all animate and inanimate objects that might occupy the occupant seating area. It will be appreciated that the classifier 54 can utilize other inputs besides the array of weight sensors 82 and the camera controller 80.

FIG. 2 illustrates a classification system 100 for classifying a vehicle occupant in accordance with an aspect of the present invention. The system includes a sensor assembly 102 that is operative to produce a plurality of training samples, selected to represent a plurality of occupant classes. The sensor assembly 102 can include, for example, any of arrays of weight sensors, a number of imagers, including imagers responsive to visible light, infrared radiation, other forms of electromagnetic radiation, and ultra sound, motion detectors, and audio sensors.

The training samples are reduced to feature vectors at a feature extractor 104. The feature extractor 104 quantifies a plurality of features from the provided training samples such that the values comprising the plurality of feature vectors provide a quantitative representation of features associated with the training samples. These feature vectors are then stored in a database 106.

Redundant feature vectors within the database are eliminated by a data pruner 108. For example, a feature vector can be eliminated when it falls within a threshold distance in the multidimensional feature space of another feature vector having the same associated class. A data modeler 109 constructs a non-parametric classification model 110 from the plurality of feature vectors. For example, the classification model 110 can be constructed as a kernel-based model or a search tree organized around an approximate nearest neighbor algorithm.

Sensor data representing a vehicle occupant can be obtained at the sensor assembly 102 and then provided to the feature extractor 104 to be reduced to an input feature vector. The feature vector is then provided to a class discriminator 112 that determines an associated output class for the vehicle occupant according to the constructed classification model. The determined output class can then be used to govern the operation of the vehicle occupant protection system.

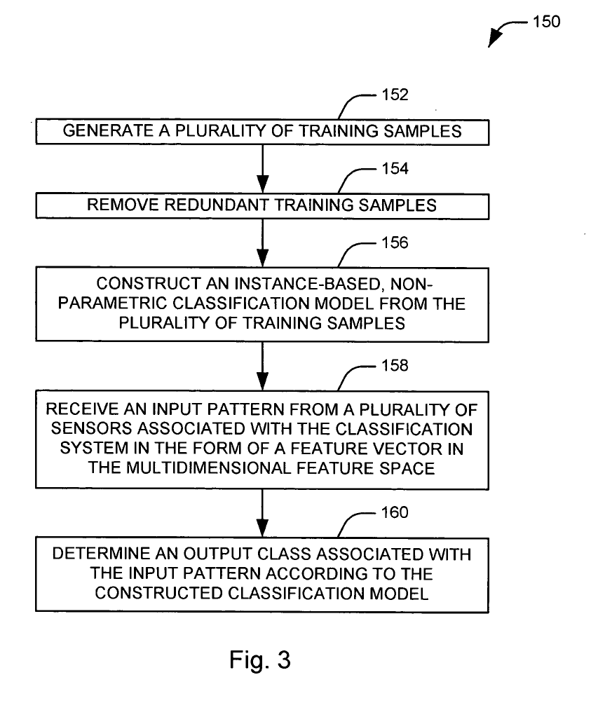

In view of the foregoing structural and functional features described above, methodologies in accordance with various aspects of the present invention will be better appreciated with reference to FIGS. 3-5. While, for purposes of simplicity of explanation, the methodology of FIGS. 3-5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 3 illustrates a method 150 for classifying a vehicle occupant in accordance with an aspect of the present invention. The method 150 begins at step 152, where a plurality of training samples, selected to represent a plurality of occupant classes, are generated. This can be accomplished in a variety of ways, including setting up models of various occupants in a vehicle interior and taking readings from a plurality of associated sensors or generating samples virtually from existing samples. The occupant classes can include any appropriate classes that may be useful in a vehicle occupant protection system, for example, an adult class, a child class, an empty seat class, a rearward facing infant seat class, a frontward facing child seat class, and one or more non-human object classes. It will be appreciated that the above listed classes are neither necessary nor exhaustive.

Each training sample is evaluated to quantify a plurality of relevant features associated with the sample as a feature vector in a multidimensional feature space. Redundant entries from the training samples can be removed at step 154, to prevent overtraining of the classifier and reduce the necessary storage size for the database of samples. A sample can be determined to be redundant when it falls within a threshold distance of another sample of the same class and a threshold distance away from any samples associated with a different class. By removing the redundant samples, an even distribution of samples can be maintained across a multidimensional feature space associated with the classification.

At step 156, an instance-based, non-parametric classification model is constructed in the multidimensional feature space from the plurality of training samples. The classification model effectively divides the multidimensional feature space into a plurality of subspaces associated with the plurality of output classes. It will be appreciated that a given output class can have one or more associated subclasses and that the one or more subspaces associated with a given output class do not need to be contiguous. It will be appreciated that the classification model, as a non-parametric model, can be dynamic, such that the hypotheses underlying the model can adapt to new training data. Accordingly, the model increases in complexity with the addition of each new training sample, but remains deterministic, allowing the performance and robustness of the model to be analyzed.

In one exemplary implementation, the classifier model can be constructed as a kernel-based model. In a kernel-based model, each training sample is used to create a local density function in the neighborhood of the training sample that indicates the likelihood that an unclassified feature vector belongs to the class associated with the training sample for a given position in the multidimensional feature space. Any of a number of kernel functions (e.g., Gaussian) can be used for this purpose. The local kernel functions derived from the plurality of training samples can be combined to form a global density function that defines the probability for each output class, over the entire multidimensional feature space, that an input feature vector is a member of the class. For example, the global density function can comprise a normalized sum of all of the local density functions.

Alternatively, the classifier model can be constructed via a nearest-neighbor approach. In the nearest neighbor approach, each training sample is represented as a vector in the multidimensional feature space having a class affiliation. The nearest neighbor model assumes that feature vectors that are proximate in the multidimensional feature space are likely to share the same class affiliation. Accordingly, the class affiliation of an input feature vector having an unknown class can be determined according to the class affiliation of the training samples closest to the feature vector in the multidimensional feature space.

At step 158, an input pattern is received from a plurality of sensors associated with the classification system in the form of a feature vector in the multidimensional feature space. At step 160, an output class associated with the input pattern is determined according to the constructed classification model. For example, in a kernel model, the probability that the input pattern belongs to a given class can be determined according to the global probability distribution defined by the classification model. In a nearest neighbor model, one or more training samples falling closest to the feature vector representing the input pattern are selected via an appropriate search algorithm and used to determine an associated class for the input feature vector. Where the selected training samples represent more than one output class, the classifier can arbitrate among the output classes via an appropriate arbitration algorithm (e.g., a voting algorithm). The determined output class is then provided as a system output.

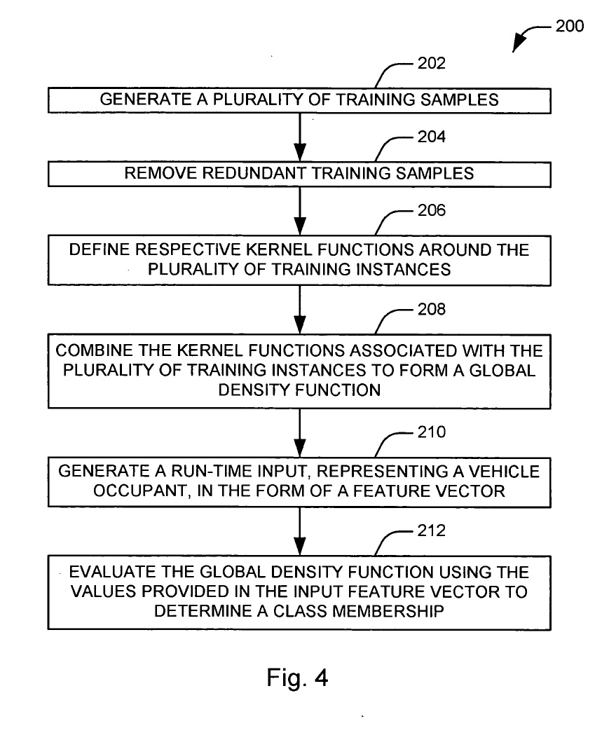

FIG. 4 illustrates an exemplary kernel-based methodology 200 for classifying a vehicle occupant in accordance with an aspect of the present invention. The methodology begins at step 202, where a plurality of training instances are generated. Each training instance has a known associated class from the plurality of output classes. The training samples can be generated in a variety of ways, including setting up models of various occupants in a vehicle interior and generating training samples from a plurality of associated sensors or generating training samples virtually from existing samples. Each training sample is evaluated to quantify a plurality of relevant features associated with the sample as a training instance, represented as a feature vector in a multidimensional feature space. It will be appreciated that the features defining the multidimensional feature space must be repeatable and distinctive to allow for effective training and modeling.

At step 204, redundant training data is removed from the plurality of training instances. For example, a training instance associated with a given class can be eliminated if one or more other instances associated with the given class are within a first threshold distance and no training instance associated with a different class is within a second threshold distance. It will be appreciated, however, that the criteria for eliminating a given training instance can be more flexible. For example, a single, variable threshold distance can be utilized for eliminating proximate training instances sharing an associated class with the threshold being a function of the distance between a given instance and the nearest training instance associated with another class. Alternatively, a fitness metric, comprising a function of the relative distances between a given instance and one or more instances of the same class and one or more instances of a different class, can be utilized for determining which instances should be eliminated. It will be appreciated that references to distance, here and throughout this paper, can refer to any appropriate distance metric, including Euclidean distance, Hamming distance, Manhattan distance, chessboard distance, and Mahalanobis distance.

At step 206, respective kernel functions are defined around the plurality of training instances. Each kernel function represents a local density function around the training instance representing the likelihood that a given coordinate point in the immediate region of the training instance belongs to the class associated with the training instance. Any of a plurality of density functions can be utilized as kernel functions for this purpose. In one implementation, the kernel function has a Gaussian distribution, such that:

$$K ( x , {x}_{i} ) = \frac{1}{{( {w}^{2} \sqrt{2 π} )}^{d}} {ⅇ}^{\frac{- {dist ( x , {x}_{i} )}^{2}}{2 {w}^{2}}} \qquad ( Eq . 1 )$$

where x represents the coordinate location of a point in the multidimensional feature space, xᵢ is the coordinate location of an i^{th} training instance in the multidimensional feature space, dist(x, xᵢ) represents the distance between x and xᵢ according to an appropriate distance metric (e.g., Euclidean, Manhattan, Mahalanobis, etc.), d is the number of dimensions (e.g., features) in the multidimensional feature space, and w² is a variance metric.

At step 208, the kernel functions associated with the plurality of training instances are combined to form a global density function. In an exemplary implementation, the global density function is a normalized sum of the kernel functions. At step 210, a run-time input, representing a vehicle occupant, is generated at the sensors and converted to a feature vector in the multidimensional feature space. At step 212, the global density function is evaluated using the values provided in the input feature vector to determine a class membership and an associated confidence value for the vehicle occupant.

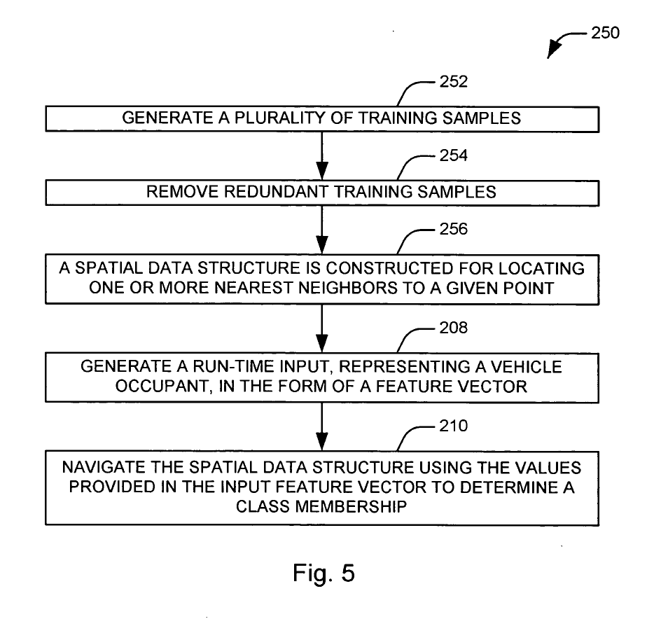

FIG. 5 illustrates an exemplary nearest neighbor methodology 250 for classifying a vehicle occupant in accordance with an aspect of the present invention. The methodology begins at step 252, where a plurality of training instances are generated. Each training instance has a known associated class from the plurality of occupant classes. The generation of the training instances can be accomplished in a variety of ways, including setting up models of various occupants in a vehicle interior and generating training samples from a plurality of associated sensors or generating training samples virtually from existing samples. Each training sample is evaluated to quantify a plurality of relevant features associated with the sample as a training instance, represented as a feature vector in a multidimensional feature space. It will be appreciated that the features defining the multidimensional feature space must be repeatable and distinctive to allow for effective training and modeling.

At step 254, redundant training data is removed from the plurality of training instances. For example, a training instance associated with a given class can be eliminated if one or more other instances associated with the given class are within a first threshold distance and no training instance associated with a different class is within a second threshold distance. It will be appreciated, however, that the criteria for eliminating a given training instance can be more flexible. For example, a single, variable threshold distance can be utilized for eliminating proximate training instances sharing an associated class with the threshold being a function of the distance between a given instance and the nearest training instance associated with another class. Alternatively, a fitness metric, comprising a function of the relative distances between a given instance and one or more instances of the same class and one or more instances of a different class, can be utilized for determining which instances should be eliminated.

At step 256, a spatial data structure, such as a search tree, is constructed for locating one or more nearest neighbors to a given point according to a nearest neighbor algorithm. In an exemplary implementation, the spatial data structure is a kd-tree. A kd-tree is a search tree used to categorize points in a multidimensional feature space with k dimensions, where k is an integer greater than 1. The levels of the tree are split along successive dimensions, such that the data is recursively bifurcated at the mean value of the dimension of maximum variance at each stage in the tree.

The search tree includes at a root node representing all of the training data. At the root node, the data is split along a first dimension of the multidimensional feature space into two subsets, generally of comparable size. A numerical threshold value representing the boundary between the two subsets is referred to as the key. The key value represents the position in feature space of a k−1 dimensional construct representing the boundary between the two subsets. This is continued for each of the next k−1 levels of the tree, with each node of a given level representing a parsing of the data into subsets along successive dimensions according to the mean of the remaining data on the branch along the dimension associated with the level. At the k+1^{st} level, the data is once again parsed along the first dimension, and the tree cycles through the dimensions until every branch of the tree terminates at leaf nodes. A branch can terminate, for example, when the number of feature vectors associated with a given node falls below a threshold level.

In a high dimensionality system, the efficiency of a nearest neighbor search may not be much, if any, higher than an exhaustive search of the training data. Accordingly, the search tree can be modified according to one of a plurality of approximate nearest neighbor algorithms to increase the efficiency of the search at a small cost in accuracy. For example, the search tree can be organized in accordance with a best bin first algorithm that rearranges the search tree such that the tree is searched according to the proximity of the data associated with the various nodes to the location of the input feature vector. Alternatively, the tree can be organized according to a locality sensitive hashing algorithm that utilizes a plurality of hashing functions to map the k-dimensional space into a feature space having less than k-dimensions. It will be appreciated that other approximate nearest neighbor algorithms can be used to increase the efficiency of the search tree.

At step 258, a run-time input, representing a vehicle occupant, is generated at the sensors and converted to a feature vector in the multidimensional feature space. At step 260, the spatial data structure is navigated to determine one or more nearest neighbors for the input feature vector. At each level, a given branch is selected by comparing the value of the input feature along the associated dimension with the key value. If the feature value is larger than the key value, a first branch is selected, and if the feature value is less than the key value, a second branch is selected. When a leaf node is reached, the distance between the input feature vector and each of the feature vectors associated with the leaf node can be determined to find a desired number of nearest neighbors within a threshold distance.

Once one or more nearest neighbors to the input feature vector have been selected, the associated classes of the selected nearest neighbors are analyzed at step 262 to determine a final output class for the vehicle occupant. It will be appreciated that this step may not be necessary when only a single nearest neighbor is utilized. When multiple nearest neighbors are utilized, an output class can be determined by an appropriate arbitration algorithm.

For example, a final class can be determined via a weighted voting scheme. Each of the selected nearest neighbors provides a vote for their associated class, weighted as a function of their distance (e.g., multiplicative inverse of distance) from the input feature vector. The class receiving the highest total vote is selected. Alternatively, the class associated with the nearest neighbor can be selected, and a fitness metric can be computed utilizing one or more of the selected nearest neighbors. For example, the ratio of the distances between the input feature vector and the nearest neighbor and the nearest training instance associated with a class different from that associated with the nearest neighbor can be computed. If the ratio fails to meet a threshold value, the selected class can be rejected.

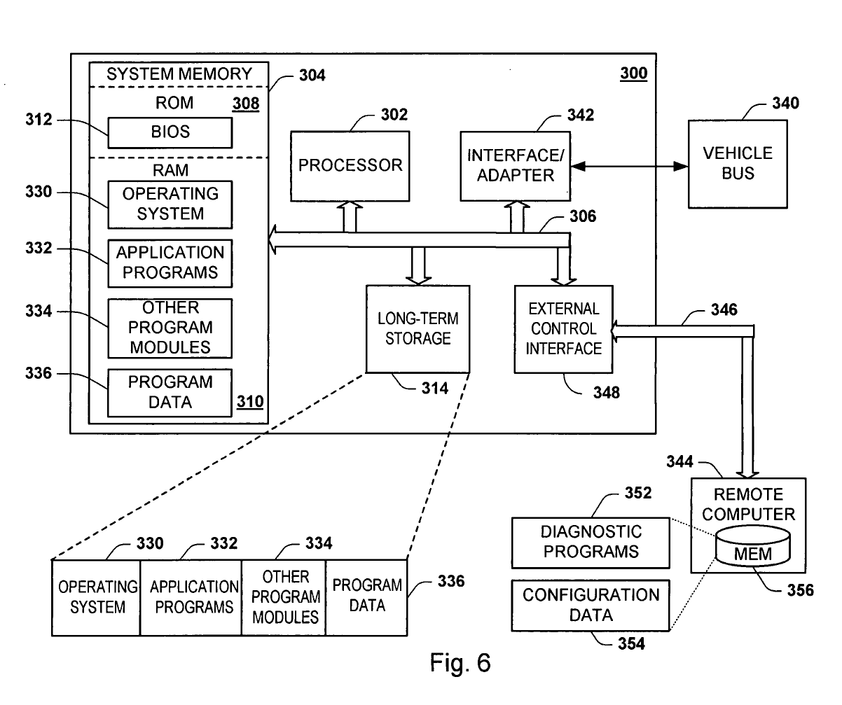

FIG. 6 illustrates a data processing system 300 that can be incorporated into a vehicle to implement systems and methods described herein, such as based on computer executable instructions running on the data processing system. The data processing system 300 can be implemented as one or more general purpose networked computer systems, embedded computer systems, routers, switches, server devices, client devices, various intermediate devices/nodes and/or stand alone computer systems. Additionally, the data processing system 300 can be implemented as part of the computer-aided engineering (CAE) tool running computer executable instructions to perform a method as described herein.

The data processing system 300 includes a processor 302 and a system memory 304. A system bus 306 couples various system components, including a coupling of the system memory 304 to the processor 302. Dual microprocessors and other multi-processor architectures can also be utilized as the processor 302. The system bus 306 can be implemented as any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) 312 can reside in the ROM 308, generally containing the basic routines that help to transfer information between elements within the computer system 300, such as a reset or power-up.

The computer system 300 can include long term storage 314, for example, a magnetic hard disk, an optical drive, magnetic cassettes, or one or more flash memory cards. The long term storage 314 can contain computer executable instructions for implementing systems and methods described herein. A number of program modules may also be stored in the long term storage as well as in the RAM 310, including an operating system 330, one or more application programs 332, other program modules 334, and program data 336.

The data processing system 300 can be connected to a vehicle bus 340 via an interface or adapter 342 to communicate with one or more vehicle systems. Additionally, the data processing system 300 can be connected to a remote computer 344 via a logical connection 346 for configuration or for diagnostic purposes through an external control interface 348. The remote computer 344 may be a workstation, a computer system, a router, a peer device or other common network node, and typically includes many or all of the elements described relative to the computer system 300. Diagnostic programs 352 and configuration data 354 may be stored in memory 356 of the remote computer 344.

From the above description of the invention, those skilled in the art will perceive improvements, changes, and modifications. Such improvements, changes, and modifications within the skill of the art are intended to be covered by the appended claims.

Having described the invention, the following is claimed:

1. A classification system for classifying an input feature vector, representing a vehicle occupant, into one of a plurality of occupant classes, comprising:
a database containing a plurality of feature vectors in a multidimensional feature space, each feature vector having an associated class from the plurality of output classes;
a data pruner that eliminates redundant feature vectors from the database;
a data modeler that constructs an instance-based, non-parametric classification model in the multidimensional feature space from the plurality of feature vectors; and
a class discriminator that selects an occupant class from the plurality of occupant classes according to the constructed classification model.

2. The system of claim 1, the data modeler being operative to construct a generalized binary search tree.

3. The system of claim 2, the data modeler being operative to construct the generalized binary search tree according to an approximate nearest neighbor algorithm.

4. The system of claim 3, the approximate nearest neighbor algorithm comprising a best bin first algorithm.

5. The system of claim 1, the classification model comprising a global density function and the data modeler being operative to define kernel functions around each of the feature vectors and construct the global density function from the defined kernel functions.

6. The system of claim 5, the data modeler being operative to compute a normalized sum of the kernel functions to produce the global density function.

7. The system of claim 1, further comprising a sensor assembly that monitors a vehicle interior to provide data associated with a vehicle occupant and a feature exactor that provides the input feature vector from the data associated with the vehicle occupant.

8. The system of claim 7, where the sensor assembly comprises an array of weight sensors located in a vehicle seat.

9. The system of claim 1, where the data pruner eliminates a feature vector when the feature vector falls within a first threshold distance of another feature vector having the same associated class and beyond a second threshold distance of all feature vectors having a different associated class.

10. The system of claim 1, the plurality of occupant classes comprising a class representing rearward facing infant seats.

11. A method for classifying an occupant into one of a plurality of output classes, comprising:
generating training data comprising a plurality of feature vectors in a multidimensional feature space, each feature vector having an associated class from the plurality of output classes;
eliminating redundant feature vectors from the training data, such that a feature vector from the plurality of feature vectors is eliminated when the feature vector falls within a first threshold distance in the multidimensional feature space of another feature vector having the same associated class and beyond a second threshold distance of all feature vectors having a different associated class;
constructing an instance-based, non-parametric classification model in the multidimensional feature space from the plurality of feature vectors;
extracting features from sensor data associated with a vehicle occupant, such that an input feature vector can be determined in the multidimensional feature space to represent the vehicle occupant; and
assigning an output class to the vehicle occupant according to the determined input feature vector and the constructed classification model.

12. The method of claim 11, wherein the step of constructing a classification model includes constructing a generalized binary search tree according to an approximate nearest neighbor algorithm.

13. The method of claim 12, the approximate nearest neighbor algorithm comprising a locality sensitive hashing algorithm.

14. The method of claim 11, wherein the classification model comprises a global density function and the step of constructing a classification model includes defining kernel functions around each of the feature vectors and constructing the global density function from the defined kernel functions.

15. The method of claim 11, the plurality of output classes comprising a class representing adult occupants of a vehicle.

16. The method of claim 11, further comprising the step of providing the assigned output class to a vehicle occupant protection system.

17. A computer program product, operative in a data processing system and embedded in a computer readable medium, for classifying a vehicle occupant comprising:
a database containing a plurality of feature vectors in a multidimensional feature space, each feature vector having an associated class from the plurality of output classes;
a data pruning module that eliminates redundant feature vectors from the plurality of feature vectors;
a data modeling module that constructs an instance-based, non-parametric classification model in the multidimensional feature space from the plurality of feature vectors; and
a class discriminator module that selects an occupant class for the vehicle occupant from the plurality of occupant classes according to the constructed classification model and an input feature vector representing the occupant.

18. The computer program product of claim 17, the data modeling algorithm being operative to construct a generalized binary search tree according to an approximate nearest neighbor algorithm.

19. The computer program product of claim 17, the classification model comprising a global density function and the data modeling algorithm being operative to define kernel functions around each of the feature vectors and construct the global density function from the defined kernel functions.

20. The computer program product of claim 17, the plurality of occupant classes comprising a class representing frontward facing child seats.
